(19) United States
(12) Patent Application Publication
(10) Pub. No.: US 2004/0195795 A1
(43) Pub. Date: Oct. 7, 2004

(54) Pull catch control device for skateboard

(76) Inventor: Shih-Ming Huang, Chang-Hua Hsien (TW)

Correspondence Address: Chi Fa Intellectual Economy, International Co., Ltd., P. O. Box No. 6-57, Junghe, Taipei, 235, TW

(21) Appl. No.: 10/407,333

(22) Filed: Apr. 7, 2003

(51) Int. Cl. B62M 1/00

(52) U.S. Cl. 280/87.042

(57) ABSTRACT

A catch control device for skateboards in accordance with the invention for applications of spring skateboards and as a manually operated control device during airborne movements, includes an opening at the upper surface of the skateboard for connecting to a resilient pull rope, and a reinforcement border below the opening for assisting the safety of the opening.

### BACKGROUND OF THE INVENTION

(a) Field of the Invention

The invention relates to a pulling catch control device for skateboards, and more particularly, to a pulling catch control device for skateboards capable of spring movements, wherein friction is produced between an upper surface of the skateboard and bottoms of feet of a user, so as to facilitate the feet to manipulate directions of the skateboard. The skateboard is provided with an opening at the center of the upper surface thereof, and below the opening is disposed with a reinforcement border and at above the opening is disposed with a resilient pull rope. On the surface of a provided deck of the skateboard is an anti-slide plane, and an anti-slide portion having more significant anti-slide effects is provided at front and rear ends thereof, respectively, such that when a user is posed on the skateboard, apparent frictions are produced between the bottoms of the user's feet and the upper surface of the skateboard using the safety catch provided by the opening and the pulling force provided by the pull rope, and thus enabling the user to further distinctly manipulate the skateboard in different directions during fancy maneuvers.

(b) Description of the Prior Art

In a common skateboard, a pull rope is generally provided therein for fancy springing, airborne maneuvers. The pull rope is disposed by tying to the center of an upper surface of a conventional skateboard, or by penetrating and tying using an opening provided in advance. However, in such method using an opening, stress of the skateboard is concentrated thereto and is hence likely to cause breakage at the central portion of the skateboard.

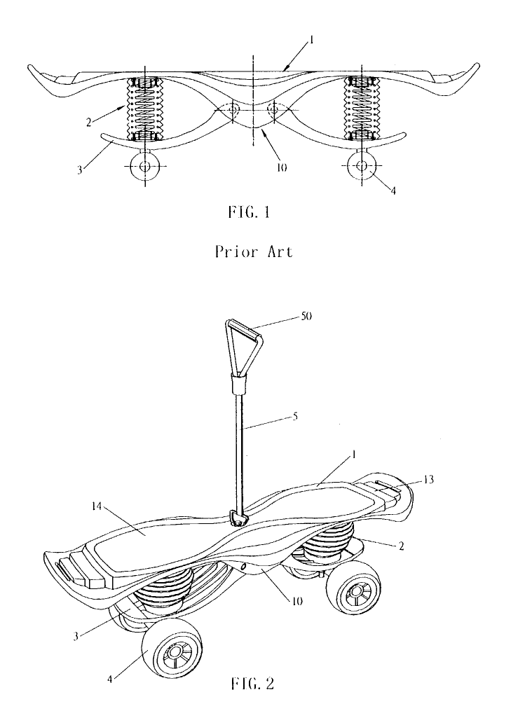

Referring to FIG. 1 showing a skateboard, the skateboard comprises a deck 1, elasticity devices 2 disposed below the deck 1, an access portion 10 at the center below of the deck 1 and for accessing corresponding ends of rocking panels 3, respectively, sliding wheels 4 disposed below the rocking panels 3, wherein the elasticity devices 2 are provided between the rocking panels 3 and the deck 1 and impose stress upon the rocking panels 3. When a user is posed on the deck 1, sliding movements are accomplished using the sliding wheels 4, and stress generated on the deck 1 is absorbed by the elasticity devices 2 acting as shock absorbers when the sliding wheels 4 encounter uneven landscapes or during springing movements; or, when the user instantaneously steps onto the deck 1, the user is provided with counteractions generated from elastic restoring forces of the elasticity devices 2 so as to have the deck 1 spring upward for further allowing the user to perform fancy airborne, springing maneuvers.

However, certain masses of various elements of the skateboard take place and actions from the gravitational force are inevitably derived. Consequently, the elastic restoring forces of the elasticity devices 2 are considered inadequate for enabling the deck 1 to freely bounce upward; that is, even if the user vigorously treads on the deck, the deck still fails to produce forces sufficient for springing upward.

Therefore, in accordance with the invention, a pull rope is especially provided at the top portion of the skateboard, so that when springing using the pull rope, the pulling forces thereof allow the entire skateboard to take off. Also, using the pulling forces, certain frictions are produced between the feet of the user and the upper surface of the skateboard for further turning or other fancy maneuvers. More particularly, at the center below the deck is provided with a reinforcement border that ensures safety of the user by dispersing stress on the deck when pulling the pull rope.

### SUMMARY OF THE INVENTION

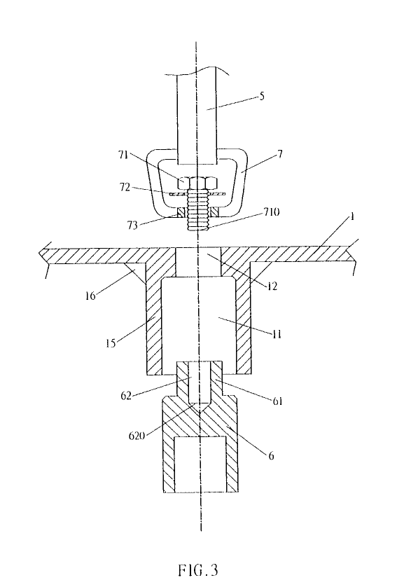

FIGS. 2 and 3 show the structure according to the invention. Referring to FIG. 2, the pull catch control device in accordance with the invention comprises a pull rope 5 at the center of the breadth of a deck 1, a sponge handle 50 formed at the center of the pull rope 5 for the user to grasp, an anti-slide plane 14 provided at the upper surface of the deck 1, an anti-slide portion 13 provided at front and rear ends of the upper surface of the deck 1, respectively, an access portion 10 provided below the deck 1, sliding wheels 4 similarly disposed below rocking panels 3, and elasticity devices 2 for producing elastic forces.

According to the above structure, the anti-slide portions 13 and the anti-slide plane 14 are for standing or pressing of the user's feet. When stepping onto the deck 1, the elasticity devices 2 generate counteractions for further producing a force allowing the deck 1 to spring upward. At the instant that the user springs upward, the user's feet momentarily come off the upper surface of the deck 1, and hence controls for directions during forward movements are not likely achieved. Therefore, using the pulling force of the pull rope 5, a hand of the user may pull the deck 1 at will, so as to produce frictions between the bottoms of the feet and the upper surface of the deck 1. To be more precise, during forward movements wherein both feet of the user may be used in coordination, when one of the feet steps on the anti-slide portion 13 of the deck 1, the other end is raised. At this point, larger frictions may be produced at the raised end by utilizing the pulling force of the pull rope 5, such that the foot at the raised end may manipulate directions of movements with respect to the skateboard. Or, when counteractions are generated by treading the deck 1 in horizontal, the pull rope 5 may also be adopted so that a perpetual balance of frictions between the two feet and the upper surface of the deck 1 may be maintained, and directions may be changed in fancy airborne maneuvers.

### BRIEF DESCRIPTION OF THE COLLECTINGS

FIG. 1 shows a conventional elevational view of a prior skateboard.

FIG. 2 shows a schematic view illustrating the position of the pull rope in an embodiment according to the invention.

FIG. 3 shows a detailed structural view of an embodiment according to the invention.

### DESCRIPTION OF THE PREFERRED EMBODIMENTS

Referring to FIG. 3 showing techniques of an embodiment according to the invention, wherein an opening 12 is provided at the center of the breadth of the deck 1, and below the opening 12 is a formed extension as a reinforcement border 15. A rib plank 16 is disposed where the reinforcement border 15 and the deck 1 come into connection, respectively. Within the reinforcement border 15 is further formed with a rectangular recess 11 for embedding a rectangular block 16. The embedded rectangular block 16 is formed with a neck portion 61 at the top thereof and a screw opening 62 at the center thereof, and the height neck portion 61 is larger than the length of the opening 12 provided at the deck 1, such that an upper end of the neck portion 61 is insert through to reach the upper surface of the deck 1 when the block 6 is embedded into the rectangular recess 11. In addition, the pull rope 5 is connected to a pull ring 7 further connected to a round link 73 for inserting a screw 71 passed through a spacer 72. When the screw 71 is secured, a lower end portion of the screw 71 butts against a bottom portion 620 of the screw opening 62 without locking the spacer 72, and thus leaving a space for allowing the pull ring 7 to freely turn in different directions. That is, when length of the screw 71 is inserted through the spacer 72 and the round link 73 provided at the pull ring 7, and a space for movements is remained without locking the spacer 72 and the round link 73, so as to have the pull ring 7 to freely turning in different directions. In addition, the pull rope 5 at the top of the pull ring 7 may be provided as fixed or using a running knot.

Therefore, using the design provided by the invention, when the embedded block 6 is withdrawn by the pull rope 5, the upward pressure formed at the embedded block 6 disperses stress over the ambits of the opening 12; and with the aid of the reinforcement border 15 and the rib planks 16, the pulling forces are also distributed toward of the deck 1, thereby ensuring the structural safety of the opening 12.

It is of course to be understood that the embodiment described herein is merely illustrative of the principles of the invention and that a wide variety of modifications thereto may be effected by persons skilled in the art without departing from the spirit and scope of the invention as set forth in the following claims.

What is claimed is:

1. A pull catch control device for skateboards for applications of spring skateboards and for effective frictions of the bottoms of feet of a user by pulling, comprising a deck, an access portion at the center below the deck for accessing rocking panels, an elasticity device provided between the rocking panels and the deck, respectively, and sliding wheels disposed below the rocking panels; and the characteristics thereof are that below an opening at the center of the deck is disposed with a reinforcement border, rib planks are disposed where the reinforcement border and the deck come into connection below the deck, respectively, the reinforcement border is further formed with a rectangular recess for embedding a rectangular block, the embedded rectangular block is formed with a neck portion at the top thereof and a screw opening at the center thereof for allowing a pull ring above the deck to fasten using the screw.

2. The pull catch control device for skateboards in accordance with claim 1, wherein the length of the neck portion of the embedded block is slightly larger than the length of the opening of the deck.

3. The pull catch control device for skateboards in accordance with claim 1, wherein the depth of the screw opening at the neck portion of the embedded block is provided according to the length of the screw, such that the pull ring is reserved with a gap for movements after fastening.
